(19) United States
(12) Patent Application Publication
(10) Pub. No.: US 2005/0087067 A1
(43) Pub. Date: Apr. 28, 2005

(54) Vacuum booster with self-locking diaphragm support

(75) Inventors: Michel J. Vermoesen, Miamisburg, OH (US); Byeung-Su Kim, Dayton, OH (US)

Correspondence Address: DELPHI TECHNOLOGIES, INC., M/C 480-410-202, PO BOX 5052, TROY, MI, 48007, US

(73) Assignee: DELPHI TECHNOLOGIES INC.

(21) Appl. No.: 10/692,633

(22) Filed: Oct. 24, 2003

(51) Int. Cl. F16J 3/00

(52) U.S. Cl. 92/99

(57) ABSTRACT

A vacuum booster 10 and method utilize a power piston apparatus 14 including a booster power piston 24, a secondary diaphragm support 26, a diaphragm support seal 28, and a primary diaphragm support 30 having an integral locking collar 32 for engaging an annular groove 34 in an outer surface 36 of the power piston 34 and clamping radially inner edges of the primary and secondary diaphragm supports 30, 26, with the diaphragm support seal 28 therebetween, in the annular groove 34 of the power piston 24. Rolling diaphragms 42, 64 are attached between outer peripheral edges 40, 62 of the primary and secondary diaphragm supports 30, 26 and a housing 12 of the booster 10.

### TECHNICAL FIELD OF THE INVENTION

This invention relates to vacuum brake boosters, and more particularly to a vacuum brake booster having diaphragm supports attached to a power piston for sealing high and low pressure cavities within the booster from one another.

### BACKGROUND OF THE INVENTION

Vehicles such as automobiles, trucks, buses, and motor homes typically include a dashboard at the front of the passenger compartment, having a power brake booster on the front of the dashboard connected by a push rod to a brake pedal mounted on the rear of the dashboard in the passenger compartment. Such power brake boosters typically include a power piston that is sealed to the inside of a booster housing by one or more rolling diaphragms.

FIG. 1 shows a typical prior tandem vacuum brake booster 100. The booster 100 includes a housing assembly 102, having a rear housing 104 adapted for connection to the front of the dashboard, and a front housing 106 adapted to receive and provide a mounting surface for a master cylinder 108 of the brake system. The housing assembly 102 of the vacuum booster 100 includes a divider 110 that divides the interior of the housing assembly into a primary chamber 112 and a secondary chamber 114, and provides sliding support for an axially movable booster power piston 116 that is connected via the push rod 118 to the brake pedal 120.

Extending radially outward from the power piston 116, in the secondary chamber 114 of the housing 102, is a secondary diaphragm support 122. In similar fashion, a primary diaphragm support 124 extends radially outward from the power piston 116 in the primary chamber 112. The primary and secondary diaphragm supports 122, 124 are fixed to the power piston 116 and move axially along an axis of motion 126 with the power piston 116.

A flexible rolling secondary diaphragm 128 has an outer periphery sealed to the inner walls of the secondary chamber 114 of the front housing 106, an inner periphery sealed to the power piston 116, and a skirt extending along the secondary diaphragm support 124 between the inner and outer peripheries of the secondary diaphragm 128, to thereby form a secondary low pressure chamber 130 between the secondary diaphragm 128 and the front wall 132 of the front housing 106 and a secondary high pressure chamber 134 between the secondary diaphragm 128 and the divider 110.

A flexible rolling primary diaphragm 136 has an outer periphery sealed to the inner wall of the primary chamber 112 of the rear housing 102, an inner periphery sealed to the power piston 116, an inner periphery sealed to the power piston 116, and a skirt extending between the inner and outer peripheries of the primary diaphragm 136, along the secondary diaphragm support 122, to thereby form a primary low pressure chamber 138 between the primary diaphragm 136 and the divider 110, and a primary high pressure chamber 140 between the primary diaphragm 136 and the rear wall 142 of the rear housing 102.

One or more air tubes 144 extend through the primary low pressure chamber 138 to connect the primary and secondary high pressure chambers 140, 134. The primary and secondary diaphragms 136, 128 include integrally formed grommets that provide a sliding seal between the air tubes 144 and the primary and secondary diaphragms 136, 128. The primary and secondary low pressure chambers 138, 130 are connected by holes 146 passing through the power piston 116.

The booster 100 includes valve elements, indicated generally by arrow 148, operably attached to the push rod 118 within the power piston 116, for selectively connecting all four chambers 138, 140, 130, 134 (i.e. the primary low pressure, secondary low pressure, primary high pressure, and secondary high pressure chambers) to a source of vacuum (not shown), such as the interior passages of an engine intake manifold, when the brake pedal 120 is not depressed. When the brake pedal 120 is depressed, the push rod 118 moves the valve elements 148 to a position where the primary and secondary low pressure chambers 138, 130 remain connected to the source of vacuum, but the primary and secondary high pressure chambers 140, 134 are connected to atmospheric air pressure around the brake booster 100.

The difference in pressure between the atmospheric pressure operating against the rear side of the primary and secondary diaphragms 136, 128, and the vacuum operating against the front side of the primary and secondary diaphragms 136, 128, generates a force against the primary and secondary diaphragm supports 124, 122 that drives the power piston 116 forward, (to the left in FIG. 1) and augments the force exerted through the push rod 118 from the brake pedal 120, acting through an internal booster output rod 150 in moving a hydraulic piston 152 in the master cylinder 108 to generate hydraulic pressure in the brake system for applying the brakes. The action of the brake booster 100 thus allows the pedal force required to generate a desired hydraulic pressure in the master cylinder 108 to be significantly less than the pedal force that would be required without the booster 100.

When the brake pedal 120 is released, after a braking event, a booster return spring 154 disposed between the front housing 106 and the power piston 116 causes the power piston 116 to move back to poise position, illustrated in FIG. 1. As the return spring 154 drives the power piston 116 back to the poise position, the valve elements 148 are momentarily positioned, as a result of the motion of the power piston and the action of springs within the valve elements, to allow the air in the primary and secondary high pressure chambers 140, 130 to escape through the valve elements 148. Once the air has escaped, the valve elements 148 return to a poised position, as shown in FIG. 1, that allows the primary and secondary high pressure chambers 140, 130 to be evacuated by the source of vacuum, to thereby equalize pressure across the primary and secondary diaphragms 136, 128.

FIG. 2 is an enlarged view showing the manner in which the primary and secondary diaphragm supports 124, 122 respectively are attached to the power piston 116 in the prior art booster 100 of FIG. 1. The power piston 116 includes a first annular groove 160 for receiving the radially inner edge of the primary diaphragm support 124, the radially inner edge of the primary diaphragm 136, and a first diaphragm support retainer 162 for clamping the radially inner edges of the primary diaphragm and diaphragm support 136, 124 against axial end walls of the first annular groove 160. In identical fashion, the power piston 116 includes a second annular groove 164 for receiving the radially inner edge of the secondary diaphragm support 122, the radially inner edge of the secondary diaphragm 128, and a second diaphragm support retainer 166 for clamping the radially inner edges of the secondary diaphragm and diaphragm support 128, 122 against axial end walls of the second annular groove 164.

It is desirable to reduce the complexity and cost of the booster 100 by eliminating the first and second diaphragm support retainers.

Large rolling diaphragms, having large thin wall sections, such as the primary and secondary diaphragms 136, 128 shown in FIG. 1, are difficult to manufacture. These diaphragms are typically fabricated from a rubber compound. Such rubber compounds inherently include hard particles of carbon black, which can result in localized weakness and tearing of the diaphragm in the area where the hard particles are located. Manufacturing procedures for rolling diaphragms made from rubber typically include filtration measures to reduce the presence of hard particles of carbon black, but experience has shown that even with filtration, it is difficult to produce rolling diaphragms with large thin wall sections in which the incidence of hard particles of carbon black is reduced to an acceptable level. It is also desirable, therefore, to provide an improved vacuum booster having rolling diaphragms that can be more readily manufactured.

### SUMMARY OF THE INVENTION

The present invention provides an improved booster, meeting the requirements discussed above, through use of a first diaphragm support having a central hole for passage therethrough of the power piston, and an integral locking collar disposed about the central hole for locking engagement with an annular groove in a booster power piston. A booster, according to the invention, may also include a second diaphragm support that is also locked into the annular groove in the power piston by the integral locking collar on the first diaphragm support.

The locking collar of the diaphragm support may include one or more spring tangs that expand for sliding the first diaphragm support along the power piston, to position the locking collar in the annular groove, and spring back for engaging and locking the first diaphragm support into the annular groove of the power piston.

A diaphragm support, according to the invention may include an imperforate, generally annular plate extending radially outward from the power piston and defining an outer periphery thereof adapted for fixed attachment of a seal for sealing a juncture between the outer periphery of the first diaphragm support and a booster housing of the booster. The booster may include a seal in the form of a rolling diaphragm having an internal bead thereof for attachment to the outer periphery of the diaphragm support and an external bead thereof adapted for attachment to the booster housing.

The present invention may also take the form of a method for assembling a booster or a power piston apparatus, according to the invention.

The foregoing and other features and advantages of the invention will become further apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross section of a prior vacuum brake booster having separate retainers for attaching a primary and a secondary diaphragm support to a power piston;

FIG. 2 is an enlarged view of a portion of the prior booster of FIG. 1, showing the manner in which the primary and secondary diaphragm supports, and the primary and secondary diaphragms are attached to the power piston;

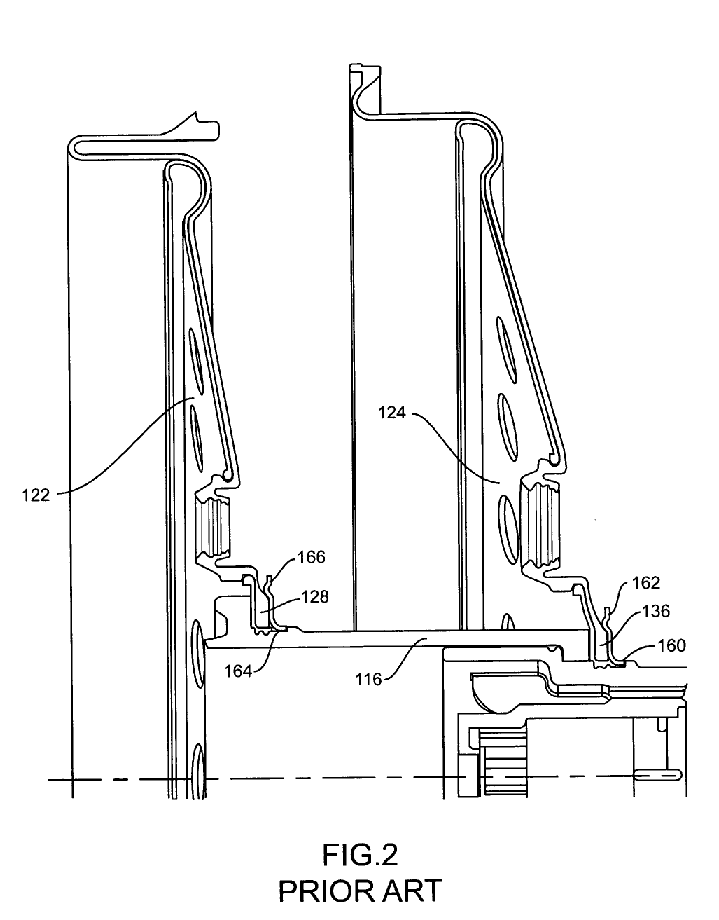

FIG. 3 is a partial cross section of an exemplary embodiment of a tandem vacuum booster, according to the invention;

FIGS. 4 and 5 are perspective views of a primary diaphragm support with an integral locking collar, of the exemplary embodiment of a booster shown in FIG. 3;

FIGS. 6 and 7, respectively, are enlarged partial cross sectional views of rolling diaphragm seals attached to the outer peripheral edges of the primary and a secondary diaphragm supports of the exemplary embodiment of the invention shown in FIG. 3; and

FIG. 8 is an enlarged cross section of a portion of the exemplary embodiment of the booster of FIG. 3, showing the manner in which the locking collar of the primary diaphragm support is used for locking both the primary and secondary diaphragm supports into an annular groove in the power piston.

### DETAILED DESCRIPTION

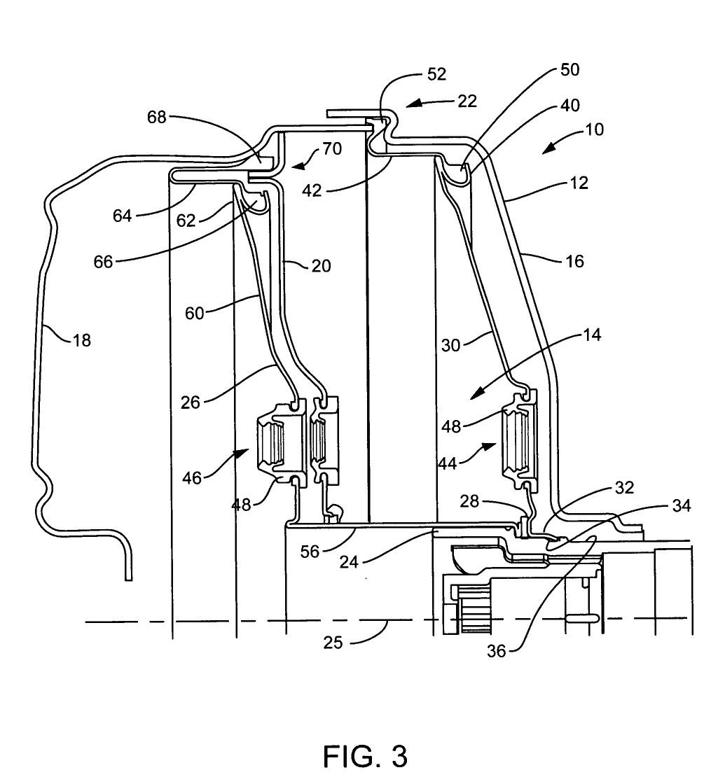

FIG. 3 shows an exemplary embodiment of the invention in the form of a tandem vacuum booster 10, including a booster housing 12 and a power piston apparatus 14.

The booster housing 12 includes a rear housing 16, adapted for attaching the booster 10 to a panel (not shown), a front housing 18, adapted for attachment of a master cylinder (not shown), and a divider 20. The front and rear housings 18, 16 and the divider 20 are all joined and sealed from the environment at a common juncture 22 of the booster housing 12. The booster housing 12 defines a longitudinal axis 25 of the booster 10.

The power piston apparatus 14 includes a booster power piston 24, a secondary diaphragm support 26, a diaphragm support seal 28, and a primary diaphragm support 30 having an integral locking collar 32 for engaging an annular groove 34 in an outer surface 36 of the power piston 24 and clamping radially inner edges of the primary and secondary diaphragm supports 26, 30, with the diaphragm support seal 28 therebetween, in the annular groove 34.

The booster power piston 24 is mounted within the booster housing 12 for movement along the longitudinal axis 25 of the booster 10, and defines a radially outer surface 36 thereof including the annular groove 34 for receiving the integral locking collar 34 of the primary diaphragm support 30.

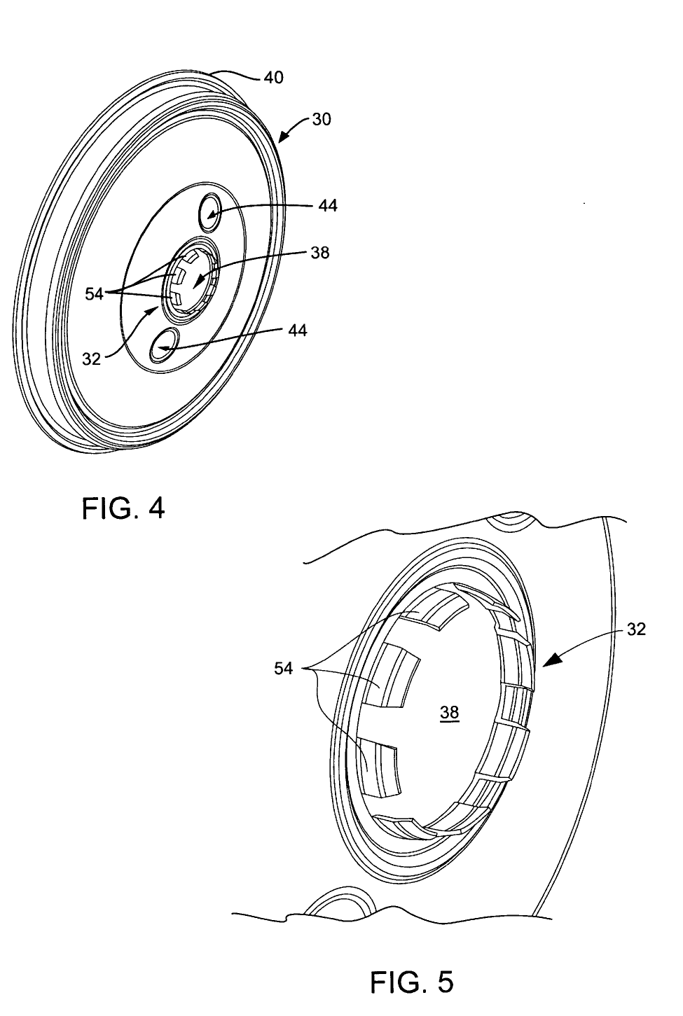

As shown in FIG. 4, the primary diaphragm support 30 includes a central hole 38 for passage therethrough of the power piston 24. The integral locking collar 32 is disposed about the central hole 38 for locking engagement with the annular groove 34 in the power piston 24. The primary diaphragm support is an imperforate, generally annular plate, extending radially outward from the power piston 24, and defining an outer periphery 40 thereof adapted for fixed attachment of a primary rolling diaphragm 42 described in greater detail below. In other embodiments of the invention, other types of seals, such as a low friction lip seal, for example, can also be used instead of a rolling diaphragm.

The term imperforate, as used herein with respect to the primary and secondary diaphragm supports 30, 26, means that once the booster 10 is assembled, the primary and secondary diaphragm supports 30, 26 define a barrier to air flow. In embodiments of the invention including tie rods extending axially through the booster housing 12, for example, the primary and secondary support diaphragms 30, 26 may include holes 44, 46, such as the ones shown in FIGS. 3, 4 and 8, for passage of the tie rods. Such holes 44, 46 are slidingly sealed to the tie rods (not shown) by sliding grommet-like seals 48 installed into the holes 44, 46 in the primary and secondary diaphragm supports 30, 26.

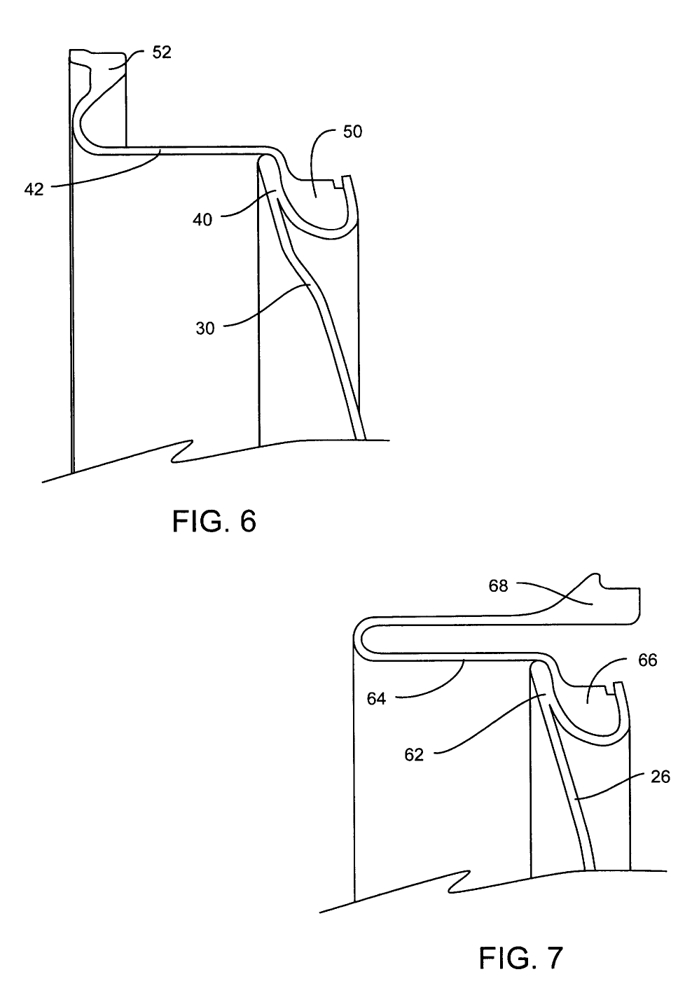

The primary rolling diaphragm 42, as shown in FIGS. 3 and 6, seals a juncture between the outer periphery 40 of the primary diaphragm support 30 and the booster housing 12. The primary rolling diaphragm 42 has an internal bead 50 thereof, for attachment to the outer periphery 40 of the primary diaphragm support 30, and an external bead 52 thereof adapted for attachment to the booster housing 12.

It will be recognized, by those having skill in the art, that the primary rolling diaphragm 42, and the secondary rolling diaphragm 64 (described below) of the present invention, are smaller in size than the rolling diaphragms used in prior vacuum boosters, and do not include large thin-walled areas. Also, the thinner areas of the primary and secondary rolling diaphragms 42, 64 of the present invention are located relatively close to the internal and external beads 50, 52, 66, 68 of the primary and secondary rolling diaphragms 42, 64. This construction results in rolling diaphragms 42, 64 that are more readily manufactured than prior rolling diaphragms, which had large thin-walled areas extending considerable distances beyond thicker-walled areas, and a construction which reduces the problems, discussed above, caused by hard particles of carbon black.

In the exemplary embodiment, the external bead 52 of the primary rolling diaphragm 42 is crimped into the common juncture 22 of the front and rear housings and divider 18, 16, 20, for sealing the common juncture 22. The outer periphery 40 of the primary diaphragm support 30, in the exemplary embodiment includes a formed annular groove for receiving and retaining the internal bead 52 of the rolling diaphragm 42. The internal bead 52 and outer periphery 40 may be sized so that the internal bead 52 is retained in the groove of the outer periphery by a radial interference fit. Other methods of attaching the internal bead 52 may also be used, in other embodiments of the invention, such as, rolling or crimping the outer periphery 40 around the internal bead 52, or adhesive bonding.

As shown, in FIGS. 4 and 5, the integral locking collar 32 of the primary diaphragm support 30 includes a plurality of spring tangs 54, circumferentially spaced around the central hole 38 of the primary diaphragm support 30. The spring tangs 54 expand, for inserting the power piston 24 through the central hole 38 and sliding the primary diaphragm support 30 along the power piston 24, to position the locking collar 32 in the annular groove 34. Once the primary diaphragm support 30 is positioned in the annular groove 34, the spring tangs 54 spring back for engaging and locking the primary diaphragm support 30 into the annular groove 34 of the power piston 24.

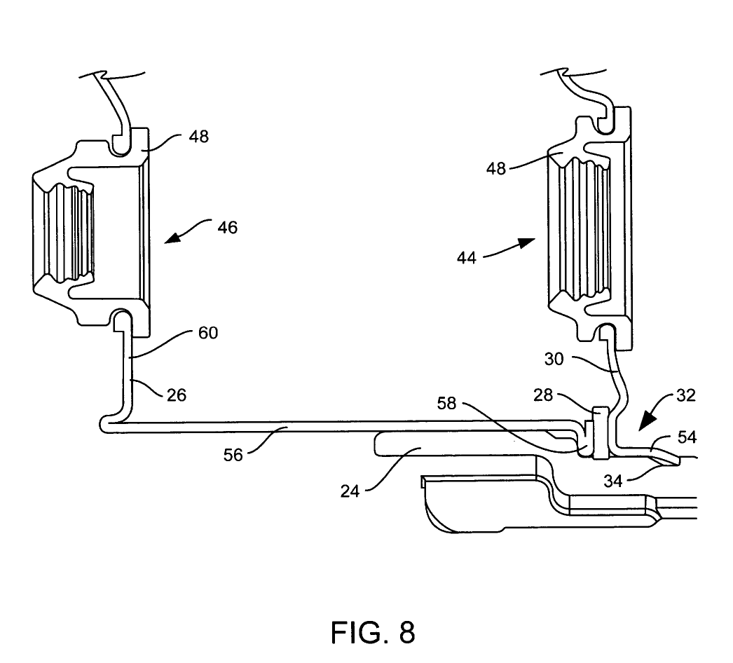

As shown, in FIGS. 3, 6, and 8, the secondary diaphragm support 26 includes a tubular, generally annular shaped wall 56 thereof, disposed about and extending along the longitudinal axis 25 of the booster 10. The first axial end (right end as shown in FIG. 8) of the tubular wall 56 includes a retaining collar 58, for engaging the annular groove 34 in power piston 24. An imperforate, radially extending flange 60 is attached to the opposite end (left end as shown in FIG. 8) of the tubular shaped wall 56 of the secondary diaphragm support 26, and extends radially outward to a distal outer peripheral edge 62 thereof, as shown in FIGS. 3 and 6, adapted for fixed attachment of a secondary rolling diaphragm 64, for sealing a juncture between the outer periphery 62 of the secondary diaphragm support 26 and the booster housing 12. In other embodiments of the invention, other types of seals, such as a low friction lip seal, for example, can also be used instead of a rolling diaphragm.

The secondary rolling diaphragm 64, as shown in FIGS. 3 and 7, seals a juncture between the outer periphery 62 of the secondary diaphragm support 26 and the booster housing 12. The secondary rolling diaphragm 64 has an internal bead 66 thereof, for attachment to the outer periphery 62 of the secondary diaphragm support 26, and an external bead 68 thereof adapted for attachment to the booster housing 12.

In the exemplary embodiment, the external bead 68 of the secondary rolling diaphragm 64 is crimped into a juncture 70 of the front housing 18 and the divider 20, for sealing the juncture 70 of the front housing 18 and the divider 20. The outer periphery 62 of the secondary diaphragm support 26, in the exemplary embodiment includes a formed annular groove for receiving and retaining the internal bead 66 of the secondary rolling diaphragm 64. The internal bead 66 and outer periphery 62 may be sized so that the internal bead 66 is retained in the groove of the outer periphery 62 by a radial interference fit. Other methods of attaching the internal bead 66 may also be used, in other embodiments of the invention, such as, rolling or crimping the outer periphery 62 around the internal bead 66, or adhesive bonding.

As shown in FIG. 8, the retaining collar 58 of the secondary diaphragm support 26 is held in place in the annular groove 34 of the power piston 24 by the spring tangs 54 of the locking collar 32 of the primary diaphragm support 30. The diaphragm support seal 28 is clamped between the primary and secondary diaphragm supports 30, 26 by the locking collar 32 of the primary diaphragm support 30, in the annular groove 34 of the power piston 24, for sealing a common juncture of the primary and secondary diaphragm supports 30, 26 and the power piston 24.

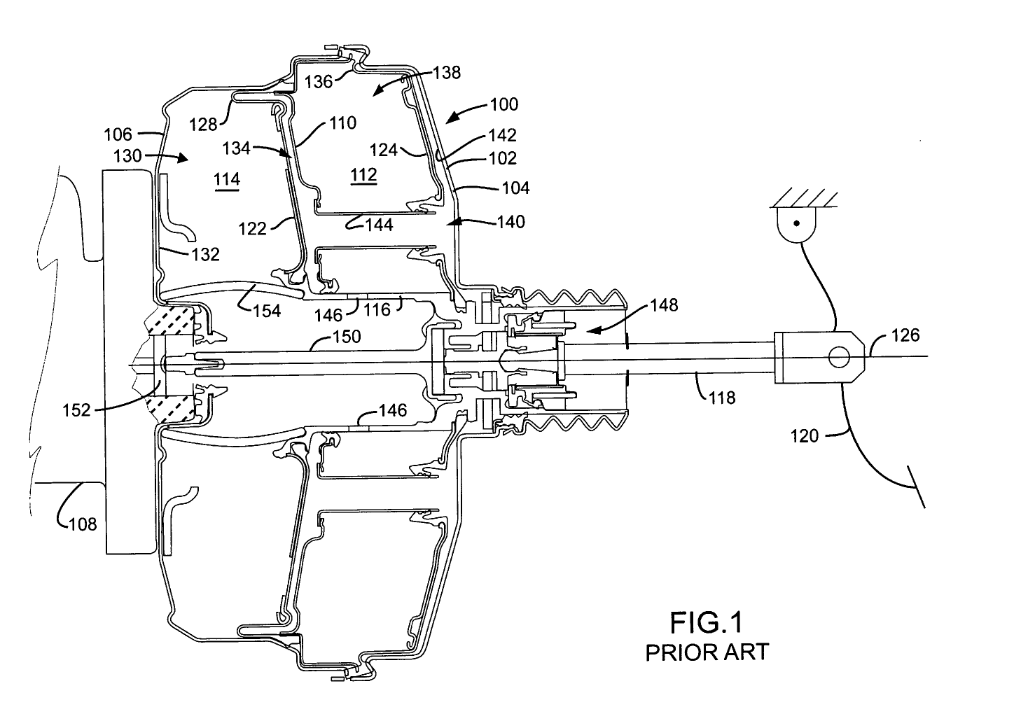

Those skilled in the art will readily recognize that, while the embodiments of the invention disclosed herein are presently considered to be preferred, various changes and modifications can be made without departing from the spirit and scope of the invention. For example, the invention can be utilized in a tandem booster as shown in FIG. 3, or in other types of single stage or tandem vacuum boosters. A booster according to the invention may also include other components commonly found in vacuum boosters, such as the air tubes 144, return spring 154, push rods 150, 118, and valve element 148 of the prior art booster 100 shown in FIG. 1. It will also be understood that a first diaphragm support with an integral locking collar, in accordance with our invention, may be used in a booster that does not include a secondary support diaphragm locked into the annular groove by the locking collar of a primary diaphragm.

The scope of the invention is indicated in the appended claims, and all changes or modifications within the meaning and range of equivalents are intended to be embraced therein.

1. A power piston apparatus, for a vacuum booster including a booster housing defining a longitudinal axis of the booster, the power piston apparatus comprising:
a booster power piston adapted to be operatively mounted within the booster housing for movement along the longitudinal axis of the booster and having a radially outer surface thereof including an annular groove therein for receiving an integral locking collar of a first diaphragm support; and
a first diaphragm support having a central hole for passage therethrough of the power piston, and an integral locking collar disposed about the central hole for locking engagement with the annular groove in the power piston.

2. The power piston apparatus of claim 1, wherein the first diaphragm support further comprises, an imperforate, generally annular plate extending radially outward from the power piston and defining an outer periphery thereof adapted for fixed attachment of a seal for sealing a juncture between the outer periphery of the first diaphragm support and the booster housing.

3. The power piston apparatus of claim 2, further including a first seal for sealing a juncture between the outer periphery of the first diaphragm support and the booster housing.

4. The power piston apparatus of claim 3 wherein the first seal is a rolling diaphragm having an internal bead thereof for attachment to the outer periphery of the first diaphragm support and an external bead thereof adapted for attachment to the booster housing.

5. The power piston apparatus of claim 1 wherein the locking collar includes one or more spring tangs that expand for sliding the first diaphragm support along the power piston, to position the locking collar in the annular groove, and spring back for engaging and locking the first diaphragm support into the annular groove of the power piston.

6. The power piston apparatus of claim 1 further comprising a diaphragm support seal in the annular groove of the power piston for sealing a juncture of the first diaphragm support and the power piston.

7. The power piston apparatus of claim 6, wherein the diaphragm support seal is retained in the annular groove of the power piston by the locking collar of the first diaphragm support.

8. The power piston apparatus of claim 1, further comprising a second diaphragm support including a tubular generally annular shaped wall thereof disposed about and extending along the longitudinal axis of the booster housing, a first axial end of the tubular wall including a retaining collar for engaging the annular groove in power piston, and an imperforate radially extending flange thereof attached to the opposite end of the tubular shaped wall of the second diaphragm support and extending radially outward to a distal outer peripheral edge thereof adapted for fixed attachment of a second seal for sealing a juncture between the outer periphery of the second diaphragm support and the booster housing.

9. The power piston apparatus of claim 8, further including a second seal for sealing a juncture between the outer periphery of the second diaphragm support and the booster housing.

10. The power piston apparatus of claim 9, wherein the second seal is a rolling diaphragm having an internal bead thereof for attachment to the outer periphery of the second diaphragm support and an external bead thereof adapted for attachment to the booster housing.

11. The power piston apparatus of claim 8, wherein the retaining collar of the second diaphragm support is held in place in the annular groove of the power piston by the locking collar of the first diaphragm support.

12. The power piston apparatus of claim 11 further comprising a diaphragm support seal disposed in the annular groove of the power piston between the first and second diaphragm supports for sealing a common juncture of the first and second diaphragm supports and the power piston.

13. The power piston apparatus of claim 12, wherein the diaphragm support seal is clamped between the first and second diaphragm supports by the locking collar of the first diaphragm support.

14. A vacuum booster comprising:
a booster housing defining a longitudinal axis of the booster; and
a power piston apparatus including a booster power piston and a first diaphragm support;
the booster power piston adapted to be operatively mounted within the booster housing for movement along the longitudinal axis of the booster and having a radially outer surface thereof including an annular groove therein for receiving an integral locking collar of a first diaphragm support;
the first diaphragm support having a central hole for passage therethrough of the power piston, and an integral locking collar disposed about the central hole for locking engagement with the annular groove in the power piston, the first diaphragm support also comprising an imperforate, generally annular plate extending radially outward from the power piston and defining an outer periphery thereof adapted for fixed attachment of a first seal for sealing a juncture between the outer periphery of the first diaphragm support and the booster housing.

15. The booster of claim 14, further including a first seal for sealing a juncture between the outer periphery of the first diaphragm support and the booster housing, wherein the first seal is a rolling diaphragm having an internal bead thereof for attachment to the outer periphery of the first diaphragm support and an external bead thereof adapted for attachment to the booster housing.

16. The booster of claim 14 wherein the locking collar includes one or more spring tangs that expand for sliding the first diaphragm support along the power piston, to position the locking collar in the annular groove, and spring back for engaging and locking the first diaphragm support into the annular groove of the power piston.

17. The booster of claim 14 further comprising a diaphragm support seal retained in the annular groove of the power piston by the locking collar of the first diaphragm support for sealing a juncture of the first diaphragm support and the power piston.

18. The booster of claim 14, further comprising:
a second diaphragm support including a tubular generally annular shaped wall thereof disposed about and extending along the longitudinal axis of the booster, a first axial end of the tubular wall including a retaining collar for engaging the annular groove in power piston, and an imperforate radially extending flange thereof attached to the opposite end of the tubular shaped wall of the second diaphragm support and extending radially outward to a distal outer peripheral edge thereof adapted for fixed attachment of a second seal for sealing a juncture between the outer periphery of the second diaphragm support and the booster housing; and
a second seal for sealing a juncture between the outer periphery of the second diaphragm support and the booster housing.

19. The power piston apparatus of claim 18, wherein the second seal is a rolling diaphragm having an internal bead thereof for attachment to the outer periphery of the second diaphragm support and an external bead thereof adapted for attachment to the booster housing.

20. The power piston apparatus of claim 18, wherein the retaining collar of the second diaphragm support is held in place in the annular groove of the power piston by the locking collar of the first diaphragm support.

21. The power piston apparatus of claim 18 further comprising a diaphragm support seal, clamped between the first and second diaphragm supports by the locking collar of the first diaphragm support, in the annular groove of the power piston, for sealing a common juncture of the first and second diaphragm supports and the power piston.

22. A method for constructing a vacuum booster, the method comprising attaching a first diaphragm support to a power piston by sliding the power piston through a central hole in the first diaphragm support and engaging a spring action locking collar of the first diaphragm support with an annular groove in the power piston.

23. The method of claim 22 further comprising sealing a juncture of the first diaphragm support and the power piston with a diaphragm support seal retained in the annular groove by the locking collar of the first diaphragm support.

24. The method of claim 22 further comprising attaching a second diaphragm support to the power piston and retaining both the first and second diaphragm supports with the locking collar of the first diaphragm support.

25. The method of claim 24 further comprising clamping the diaphragm support seal in the annular groove of the power piston between the first and second diaphragm supports with the locking collar of the first diaphragm support for sealing a common juncture of the first and second diaphragm supports and the power piston.
